(19) United States
(12) Patent Application Publication
(10) Pub. No.: US 2003/0193958 A1
(43) Pub. Date: Oct. 16, 2003

(54) Methods for providing rendezvous point router redundancy in sparse mode multicast networks

(76) Inventor: Vidya Narayanan, Schaumburg, IL (US)

Correspondence Address: MOTOROLA, INC., 1303 EAST ALGONQUIN ROAD, IL01/3RD, SCHAUMBURG, IL, 60196

(21) Appl. No.: 10/120,820

(22) Filed: Apr. 11, 2002

(51) Int. Cl. H04L 12/28; H04L 12/56

(52) U.S. Cl. 370/400; 370/342

(57) ABSTRACT

Router elements R1, R2 of a packet network 100 using a sparse mode multicast protocol are configured as candidate rendezvous points (RPs). The candidate RPs use a virtual IP address. In each shared subnet, there is selected from among the candidate RPs a single designated candidate rendezvous point (DCRP) and zero or more virtual candidate rendezvous points (VCRPs). The DCRP serves as an active candidate RP (and when elected, performs RP functions); and the VCRP(s) serve as backup to the DCRP. The VCRP(s) maintain state information to facilitate rapid takeover of DCRP functionality upon failure of the DCRP. In one embodiment, geographically separate domains 1006, 1008 are each implemented with separate active DCRPs, defining multiple, simultaneously active anycast RPs (DCRP1, DCRP2) with MSDP peering between the DCRPs. The DCRP(s) may include backup VCRP(s) for redundancy.

### FIELD OF THE INVENTION

The present invention relates generally to Internet Protocol (IP) multicast-based communication networks and, more particularly, to sparse mode multicast networks incorporating Rendezvous Points (RPs).

### BACKGROUND OF THE INVENTION

IP Multicast technology has become increasingly important in recent years. Generally, IP multicasting protocols provide one-to-many or many-to-many communication of packets representative of voice, video, data or control traffic between various endpoints (or “hosts” in IP terminology) of a packet network. Examples of hosts include, without limitation, base stations, consoles, zone controllers, mobile or portable radio units, computers, telephones, modems, fax machines, printers, personal digital assistants (PDA), cellular telephones, office and/or home appliances, and the like. Examples of packet networks include the Internet, Ethernet networks, local area networks (LANs), personal area networks (PANs), wide area networks (WANs) and mobile networks, alone or in combination. Node interconnections within or between packet networks may be provided by wired connections, such as telephone lines, T1 lines, coaxial cable, fiber optic cables, etc. and/or by wireless links.

Multicast distribution of packets throughout the packet network is performed by various network routing devices (“routers”) that operate to define a spanning tree of router interfaces and necessary paths between those interfaces leading to members of the multicast group. The spanning tree of router interfaces and paths is frequently referred to as a multicast routing tree. Presently, there are two fundamental types of IP multicast routing protocols, commonly referred to as sparse mode and dense mode. Generally, in sparse mode, the routing tree for a particular multicast group is pre-configured to branch only to endpoints having joined an associated multicast address; whereas dense mode employs a “flood-and-prune” operation whereby the routing tree initially branches to all endpoints of the network and then is scaled back (or pruned) to eliminate unnecessary paths. As will be appreciated, the choice of sparse or dense mode is an implementation decision that depends on factors including, for example, the network topology and the number of source and recipient devices in the network.

For networks employing sparse mode protocols (e.g., Protocol Independent Mode-Sparse Mode (PIM-SM)), it is known to define a router element known as a rendezvous point (RP) to facilitate building and tearing down the multicast tree, as well as duplication and routing of packets throughout the multicast tree. In effect, an RP is a router that has been configured to be used as the root of the shared distribution tree for a multicast group. Hosts desiring to receive messages for a particular group (i.e., receivers) send Join messages towards the RP; and hosts sending messages for the group (i.e., senders) send data to the RP that allows the receivers to discover who the senders are, and to start to receive traffic destined for the group. The RP maintains state information that identifies which member(s) have joined the multicast group, which member(s) are senders or receivers of packets, and so forth. A routing path or branch is established from the RP to every member node of the multicast group. As packets are sourced from a sending device, they are received and duplicated, as necessary, by the RP and forwarded to receiving device(s) via appropriate branches of the multicast tree. The RP may also cause paths to be torn down as may be appropriate upon members leaving the multicast group.

A problem that arises is that, inasmuch as the RP represents a critical hub shared by all paths of the multicast tree, all communication to the multicast group is lost (at least temporarily) if the RP were to fail. A related problem is that sparse mode protocols such as PIM-SM only allow one RP to be active at any given time for a particular group range of multicast addresses. Hence, in a network supporting multiple group ranges, each range may have an active RP. In the event of a failure of any of the active RPs, there is a need to transition RP functionality from the failed RP(s) to backup RP(s) to restore communications to the affected multicast group(s). Presently, however, the time required for the network to detect failure of an RP and elect a new RP and for the new RP to establish necessary paths to all members of the multicast group can take as long as 210 seconds. Such large delays are intolerable for networks supporting multimedia communications (most particularly time-critical, high-frame-rate streaming voice and video), yet this time generally can not be reduced using known methods without imposing other adverse effects (e.g., bandwidth, quality, etc.) on the network.

Accordingly, there is a need for methods to provide RP redundancy in a sparse mode multicast network in a manner that facilitates a more seamless, rapid failover from active RP(s) to backup RP(s). Advantageously, the methods will provide for failover from active to backup RP(s) on the order of tens of seconds, or less, without significant adverse effects on bandwidth, quality, and the like. The present invention is directed to satisfying, or at least partially satisfying, these needs.

### BRIEF DESCRIPTION OF THE DRAWINGS

The foregoing and other advantages of the invention will become apparent upon reading the following detailed description and upon reference to the drawings in which:

FIG. 1 shows a portion of a multicast network incorporating a plurality of candidate RPs, wherein a first one of the candidate RPs defines a designated candidate RP (DCRP), the DCRP having been elected as the active RP for a particular multicast group, and a second one of the candidate RPs defines a virtual candidate RP (VCRP) according to one embodiment of the present invention;

FIG. 2 shows various messages sent from a sender, receiver and RP in the multicast network of FIG. 1;

FIG. 3 shows the multicast network of FIG. 1 after the first candidate RP becomes failed, causing DCRP functionality to transition from the first candidate RP to the second candidate RP;

FIG. 4 shows the multicast network of FIG. 2 after the first candidate RP becomes recovered, causing DCRP functionality to transition back to the first candidate RP;

FIG. 5 is a flowchart showing steps to elect a DCRP and VCRP from among candidate RPs within the same group range according to one embodiment of the present invention;

FIG. 6 is a flowchart showing DCRP behavior according to one embodiment of the present invention;

FIG. 7 is a flowchart showing VCRP behavior according to one embodiment of the present invention;

FIG. 8 is a flowchart showing VCRP behavior upon failure of a DCRP according to one embodiment of the present invention;

FIG. 9 is a flowchart showing behavior of an active DCRP (formerly a VCRP) upon recovery of a former DCRP according to one embodiment of the present invention;

FIG. 10 shows a portion of a multicast network having geographically separate domains each incorporating a plurality of candidate RPs according to one embodiment of the present invention, whereby a first candidate RP defines a designated candidate RP (DCRP) in each respective domain, yielding simultaneously active DCRPs in the multicast network;

FIG. 11 shows the multicast network of FIG. 10 after transition of DCRP functionality in the first domain from the first candidate RP, now failed, to a second candidate RP, the second candidate RP now acting as the DCRP in the first domain; and

FIG. 12 is a flowchart showing steps performed to establish DCRPs in geographically separate domains and, upon DCRP failure, to elect new DCRP(s) according to one embodiment of the present invention.

### DESCRIPTION OF A PREFERRED EMBODIMENT

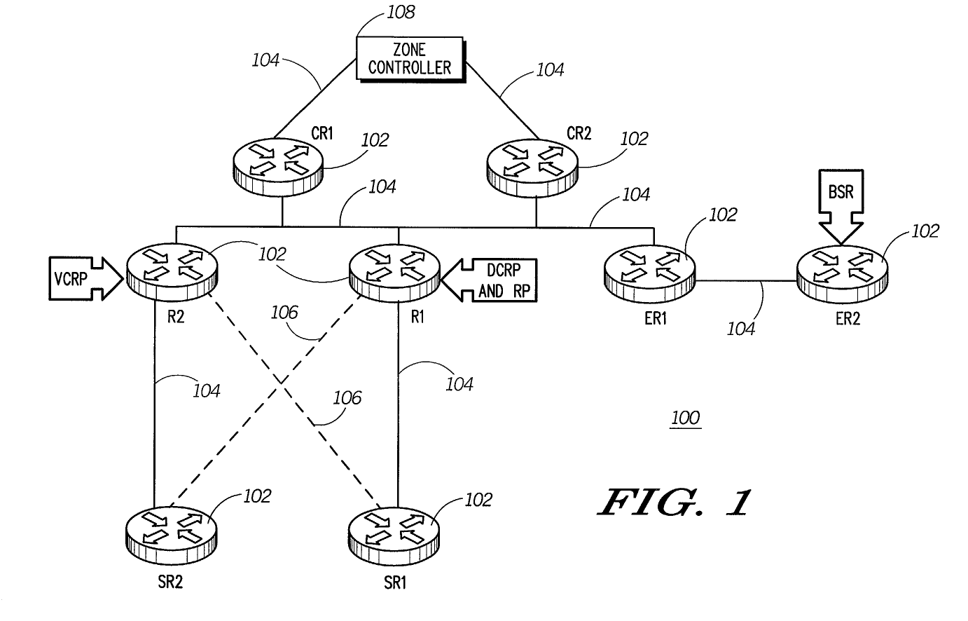

Turning now to the drawings and referring initially to FIG. 1, there is shown a portion of an IP multicast communication system (or “network”) 100. Generally, the network 100 comprises a plurality of router elements 102 interconnected by links 104, 106. The router elements 102 are functional elements that may be embodied in separate physical routers or combinations of routers. For convenience, the router elements will hereinafter be referred to as “routers.” The links 104, 106 comprise generally any commercial or proprietary medium (for example, Ethernet, Token Ring, Frame Relay, PPP or any commercial or proprietary LAN or WAN technology) operable to transport IP packets between and among the routers 102 and any attached hosts.

For purposes of example and not limitation, FIG. 1 presumes that the communication network 100 is a part of a multicast-based radio communication system including mobile or portable wireless radio units (not shown) distributed among various radio frequency (RF) sites (not shown). To that end, there is shown a zone controller/server 108 of the type often used to manage and assign IP multicast addresses for payload (voice, data, video, etc.) and control messages between and among the various radio frequency (RF) sites. However, as will be appreciated, the network 100 may comprise virtually any type of multicast packet network with virtually any number and/or type of attached hosts.

As shown, the routers 102 of the network 100 are denoted according to their function(s) relative to the presumed radio communication system. Routers “CR1” and “CR2” are control routers which pass control information between the zone controller 106 and the rest of the communication network 100. Routers “SR1” and “SR2” are local site routers associated with RF sites which, depending on call activity of participating devices at their respective sites, may comprise either senders or receivers of IP packets relative to the network 100.

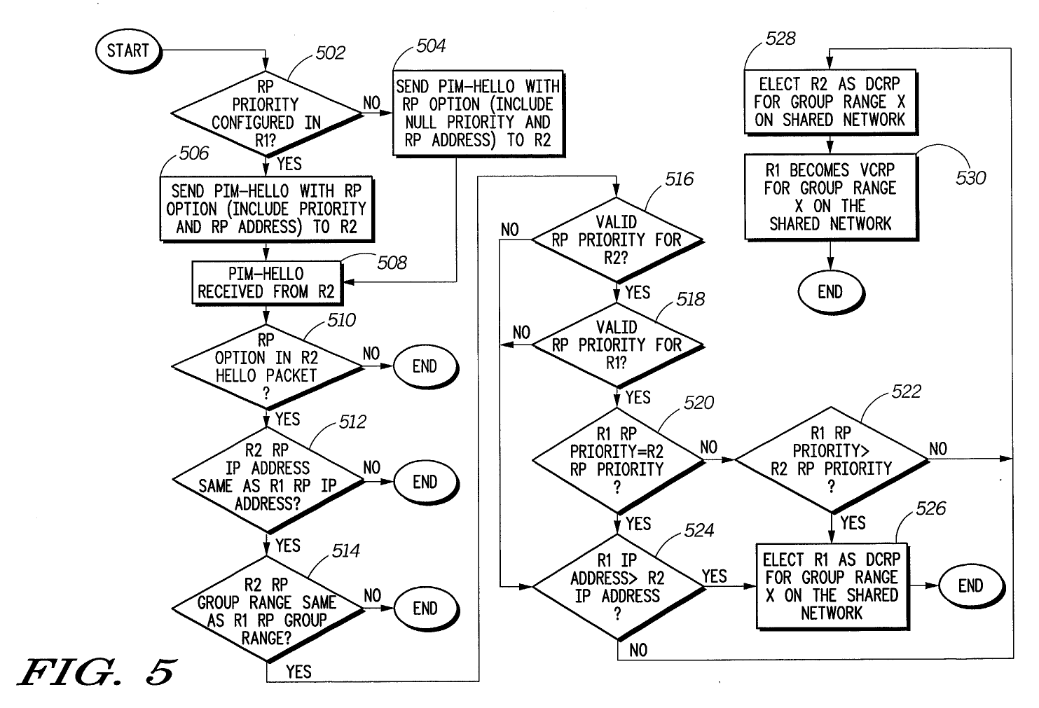

Routers R1 and R2 are candidate RPs for a shared subnet of the network 100. The candidate RPs share a common “virtual” unicast IP address. Generally, according to principles of the present invention, one of the candidate RPs is elected as a “DCRP,” or Designated Candidate RP, and the other (non-elected) candidate RP becomes a “VCRP,” or Virtual Candidate RP. Candidate RP configuration can be done on any number of routers on a particular subnet, but only one candidate RP is elected DCRP and the remaining candidate RP(s) become VCRP(s). The determination of which candidate RP(s) become DCRP and which become VCRP(s) will be described in relation to FIG. 5.

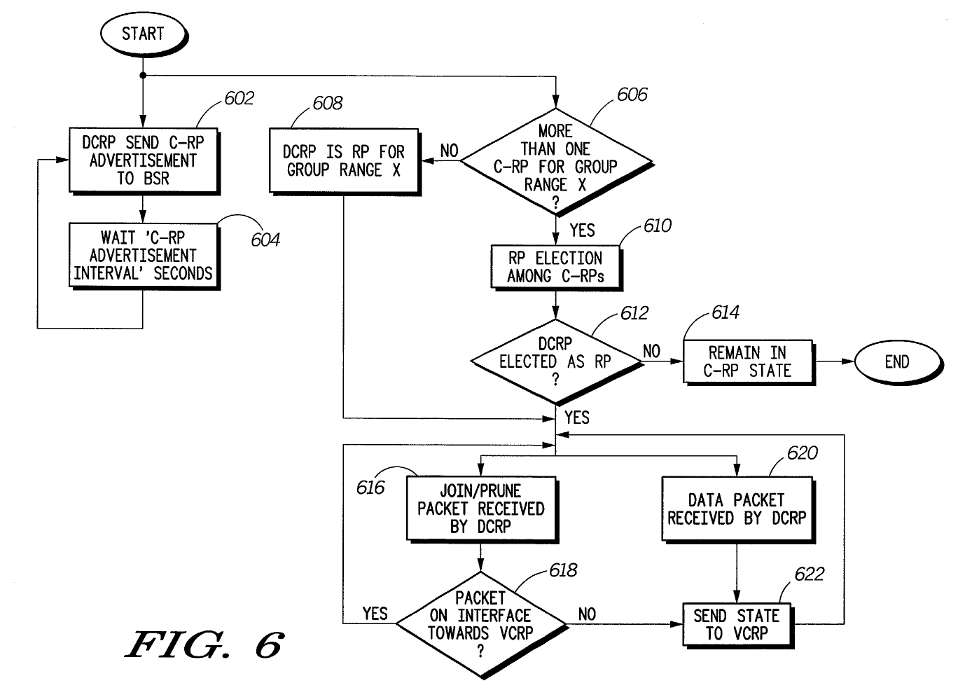

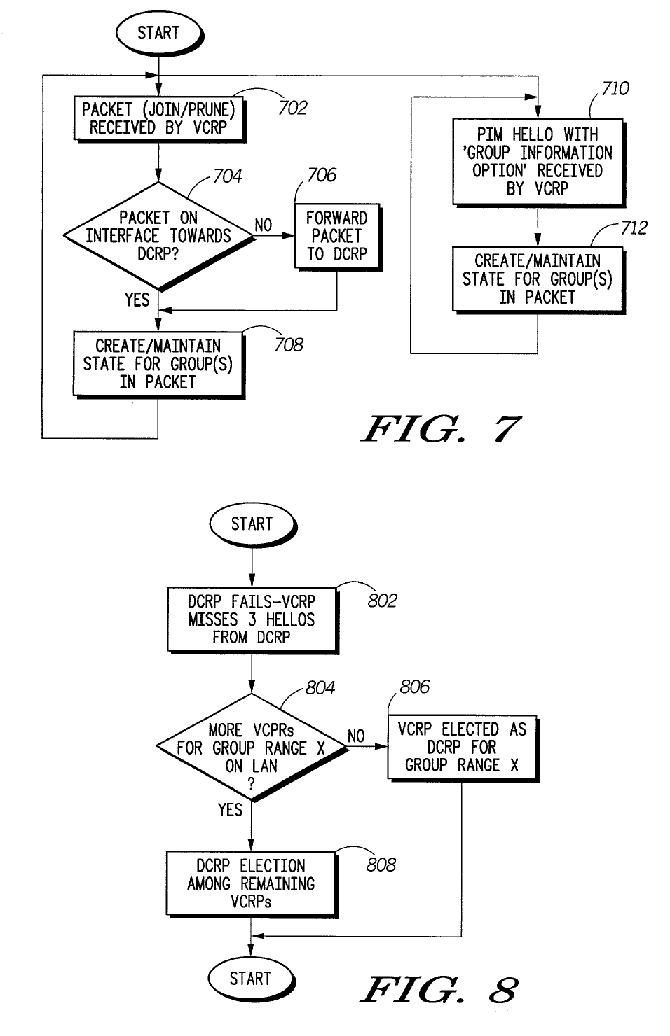

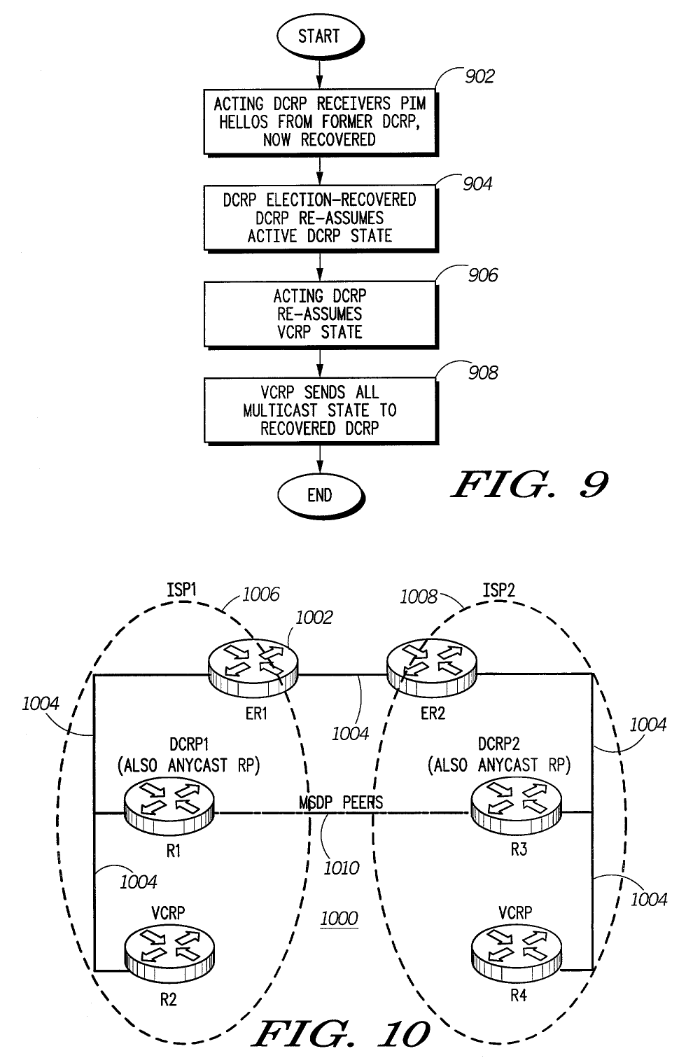

As shown, R1 is DCRP and R2 is VCRP for their shared subnet. The functions performed by the DCRP will be described in relation to FIG. 6 and the functions performed by the VCRP will be described in relation to FIG. 7. In effect, the DCRP is an active candidate RP and the VCRP is a passive candidate RP for a particular subnet. As will be described, one of the functions of the DCRP is to elect a designated “active” RP for a particular multicast group from among all candidate DCRPs. As shown, R1 is denoted “RP,” indicating it has been elected active RP. As has been described, the elected RP (e.g., R1) facilitates building (and, when appropriate, tearing down) the multicast tree for a particular multicast group according to PIM-SM protocol (or suitable alternative). The non-elected RP, or VCRP (e.g., R2), is adapted to quickly take over the DCRP function in the event of failure of the active DCRP but, until such time, is otherwise substantially transparent to the other routers of the network. The behavior of a VCRP upon failure of a DCRP is shown in FIG. 8; and the behavior of the VCRP (having become an active DCRP after having taken over the DCRP function) upon recovery of the former DCRP is shown in FIG. 9.

Routers “ER1” and “ER2” are exit routers leading away from the RP, or more generally, leading away from the portion of the network associated with the zone controller 108. The exit routers ER1 and ER2 may connect, for example, to different zones of a multi-zone radio communication system, or may connect the radio communication system to different communication network(s). As shown, ER2 is denoted “BSR,” indicating that ER2 is a Bootstrap Router. Generally, the BSR manages and distributes RP information between and among multiple RPs of a PIM-SM network. To that end, the BSR receives periodic updates from RP(s) associated with different multicast groups. In the preferred embodiment, from a particular pair of candidate RPs on the same subnet, the BSR will only receive updates from the DCRP. That is, the BSR does not receive updates from the VCRP unless the VCRP takes over DCRP functionality from a failed DCRP. The BSR will not necessarily know which of the candidate RPs (e.g., R1, R2) is acting as DCRP and VCRP.

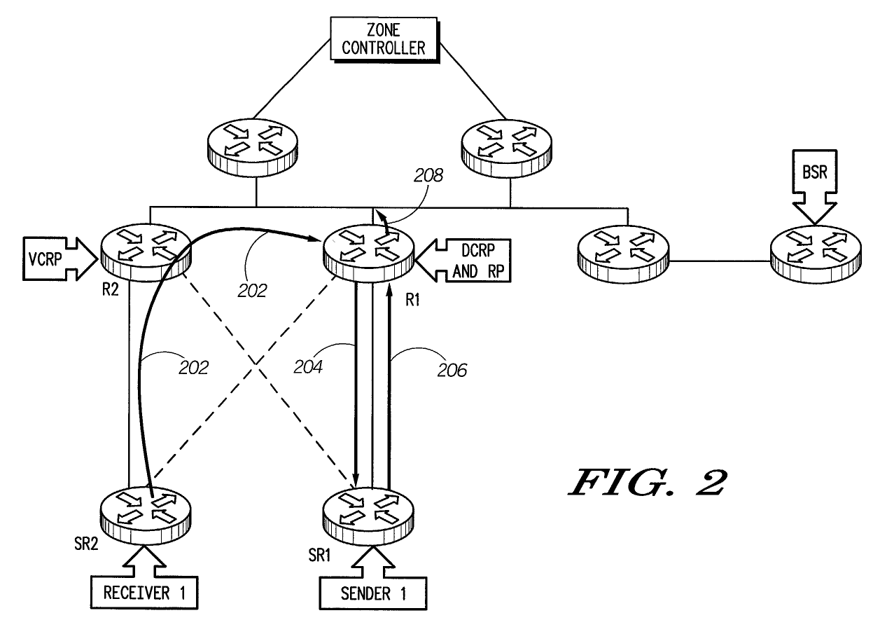

Now turning to FIG. 2, there are shown various messages sent from a sender, receiver and RP in the multicast network of FIG. 1. FIG. 2 presumes that SR1 is a sender (denoted “Sender 1”) and SR2 is a receiver (denoted “Receiver 1”) of IP packets addressed to a particular multicast group. As will be appreciated, the term “Sender 1” and “Receiver 1” are relative terms as applied to SR1, SR2 because SR1, SR2 are typically not the ultimate source and destination of multicast packets, but rather intermediate devices attached to sending and receiving hosts (not shown), respectively. For example, in the case where SR1 and SR2 are local site routers associated with RF sites, the source and destination of IP packets addressed to a multicast group may comprise the RF sites themselves, wireless communication unit(s) affiliated with the RF sites or generally any IP host device at the RF sites including, but not limited to, repeater/base station(s), console(s), router(s), site controller(s), comparator/voter(s), scanner(s), site controller(s), telephone interconnect device(s) or internet protocol telephony device(s) may be a source or recipient of packet data.

Host devices desiring to receive IP packets send Internet Group Management Protocol (IGMP) “Join” messages to their local router(s). In turn, the routers of the network propagate PIM-SM “Join” message toward the RP to build a spanning tree of router interfaces and necessary routes between those interfaces between the receiver and RP. When the sender becomes active and starts sending data, the RP in turn sends a PIM-SM Join towards the sender to extend the multicast tree all the way to the sender. This creates the complete multicast tree between the receiver and the sender.

In the present example, SR2 sends PIM-SM Join message 202 to the virtual unicast IP address shared by R1 and R2. Both R1 and R2 receive the Join message 202 but only R1, acting as DCRP, acts upon the Join message. The sender SR1 sources a message 206 into the network. The DCRP (e.g., R1) sends PIM-SM Join message 204 to SR1 to establish a routing tree between the receiver SR2 and sender SR1. The message 206 is received by the DCRP (e.g., R1) which duplicates packets, as may be necessary, and routes the message to the receiver SR2. The DCRP sends state information 208 (e.g., defining senders, receivers, multicast groups, etc.) to the VCRP to facilitate the VCRP performing a rapid takeover of DCRP functionality, if necessary, should the DCRP become failed.

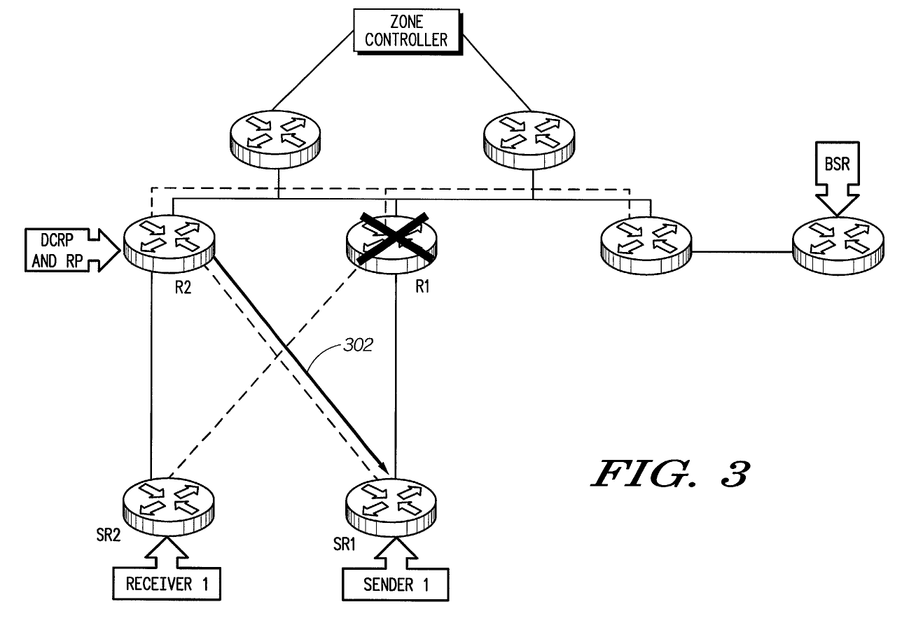

FIG. 3 shows the multicast network 100 after the initial DCRP (e.g., R1) becomes failed, causing DCRP functionality to transition to the former VCRP (now DCRP) R2. FIG. 3 presumes that R2, upon assuming DCRP functionality, is also elected RP for the multicast group(s) formerly served by R1. The new DCRP, having received state information while serving as VCRP, is aware of the sender and receiver connected to SR1 and SR2 respectively. The new DCRP (e.g., R2) sends a PIM-SM Join message 302 to SR1 to establish a routing tree between the receiver SR2 and sender SR1. Note that since R1 is failed, the message 302 is sent via an alternate path (e.g., link 106) to establish a routing tree that does not extend through R1. Note further that SR2 need not send a new Join message to receive packets sourced from Sender1.

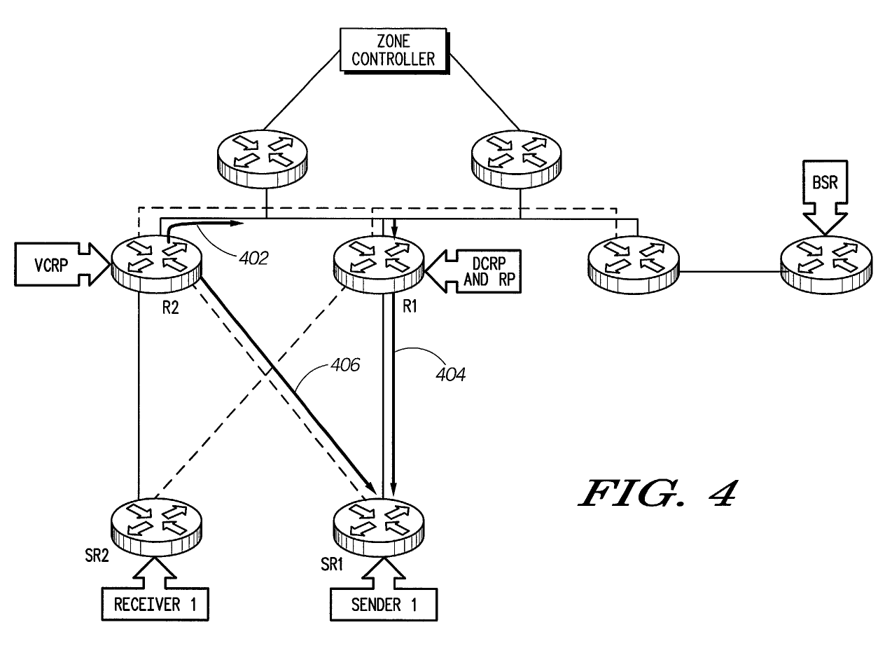

FIG. 4 shows the multicast network 100 after the failed DCRP (e.g., R1) becomes recovered, causing DCRP functionality to transition back to R1. FIG. 4 presumes that R1, upon re-assuming DCRP functionality, is re-elected RP for the multicast group(s) served temporarily by R2. Upon re-election of R1 as DCRP and RP, R2 re-assumes VCRP functionality. R2 sends state information 402 (e.g., defining senders, receivers, multicast groups, etc.) to R1 to enable R1 to re-assume DCRP functionality. The recovered DCRP (e.g., R1) sends a PIM-SM Join message 404 to SR1 to establish a new routing tree, through R1, between the receiver SR2 and sender SR1. The re-assumed VCRP (e.g., R2) sends a PIM-SM Prune message 406 to SR1 to eliminate or “prune” the branch of the multicast tree extending along alternate path 106.

FIG. 5 is a flowchart showing steps to elect a DCRP and VCRP from among candidate RPs within the same group range (i.e., range of multicast group addresses served by the DCRP/VCRP) according to one embodiment of the present invention. In one embodiment, the steps of FIG. 5 are implemented, where applicable, using stored software routines within the candidate RP(s) for a particular group range. For example, with reference to FIG. 1, the flowchart of FIG. 5 may be used by R1 and/or R2 to determine which router should become DCRP and VCRP, respectively. For convenience, the steps of FIG. 5 are shown with reference to router R1 (i.e., steps performed by R1).

At step 502, candidate RPs (e.g., R1 and R2) determine whether they have a pre-configured RP priority. The priority may comprise, for example, a number, level, “flag,” or the like that determinatively or comparatively may be used to establish priority between candidate RPs. As will be appreciated, the RP priority may be implemented as numeric value(s), Boolean value(s) or generally any manner known or devised in the future for establishing priority between peer devices.

If a candidate RP does not have a pre-configured priority, it sends at step 504 a message indicating as such to the other candidate RP(s). In one embodiment, this message comprises a PIM-SM “Hello” message with RP option identifying a “NULL” priority, which message also identifies the IP address of the candidate RP. Otherwise, if a candidate RP does have a pre-configured priority, it includes its priority and IP address within the Hello message with RP option. Thus, in the present example, if R1 does not have a pre-configured priority, it sends to R2 at step 504 a Hello message with RP option indicating a NULL priority as well as R1's RP IP address. If RI does have a pre-configured priority, it sends to R2 at step 506 a Hello message with RP option indicating R1's priority and RP IP address. As will be appreciated, communication of priority levels between candidate RPs may be accomplished alternatively or additionally by messages other than Hello messages.

At step 508, candidate RPs receive Hello message(s) from their counterpart candidate RP(s). As shown, R1 receives a PIM-Hello from R2. At step 510, R1 determines whether the Hello message from R2 includes an RP option. As has been described, a Hello message with RP option may identify the RP priority and RP IP address of R2. The RP option may also identify the group range of R2. If, at step 510, the Hello message is determined not to include an RP option, the process ends with no election of DCRP/VCRP. This may occur, for example, if R2 does not support the RP option; or if R2 supports the RP option but is not a candidate RP. If the Hello message includes the RP option, the process proceeds to step 512.

At steps 512, 514, candidate RPs determine if the RP IP address from the counterpart candidate RP(s) match their own RP IP address (i.e., they share the same “virtual” unicast IP address) and whether they share the same group range, respectively. As shown, R1 determines at step 512 whether R2's RP IP address is the same as its own RP IP address and at step 514 whether R2 and R1 share the same group range. If either the RP IP address or group range do not match, the process ends with no election of DCRP/VCRP. Otherwise, if both the RP IP address and group range are the same, the process proceeds to step 516.

At step 516, the candidate RPs determine if their counterpart candidate RP(s) have valid (i.e., non-NULL) RP priority and at step 518, whether they themselves have a valid RP priority. Thus, as shown, RI determines at step 516 whether R2 has a valid RP priority and at step 518, whether R1 itself has a valid priority. If either of these determinations is false (e.g., either R1 or R2 have NULL priority), the process proceeds to step 524 where RP priority is determined on the basis of which candidate RP has the higher IP address.

It is noted, in the present example, R1 and R2 have already been determined to have identical RP IP addresses. In one embodiment, even though R1 and R2 have the Candidate RPs configured on an identical “virtual” unicast IP address, they also have their own different “physical” IP address that differ from the RP IP address. The election, when based on IP address, makes use of these physical IP addresses of the routers R1 and R2. As shown, R1 determines at step 524 whether its own IP address is greater than R2's IP address. If R1 has the greater IP address, R1 is elected DCRP at step 526 for the common group range “X” on the shared network. If R1 does not have the greater IP address, R2 is elected DCRP at step 528 for the common group range “X” on the shared network and, at step 530, R1 becomes the VCRP.

If both R1 and R2 have valid RP priority, it is determined at step 520 whether the R1 and R2 RP priorities are the same. If the RP priorities are the same, the process proceeds to step 524 where RP priority is determined on the basis of which candidate RP has the higher IP address, as has been described. Otherwise, the process proceeds to step 522 where RP priority is determined based on RP priority. R1 determines at step 522 whether its own RP priority is greater than R2's RP priority. If R1 has the greater RP priority, R1 is elected DCRP at step 526 for the common group range “X” on the shared network. If R1 does not have the greater RP priority, R2 is elected DCRP at step 528 for the group range “X” on the shared network and, at step 530, R1 becomes the VCRP.

FIG. 6 is a flowchart showing DCRP behavior according to one embodiment of the present invention. The steps of FIG. 6 are implemented, where applicable, using stored software routines within the DCRP (e.g., R1) elected from among a plurality of candidate RP(s) for a particular group range.

At step 602, the DCRP sends a candidate-RP (C-RP) advertisement to the bootstrap router (“BSR”). As has been described in relation to FIG. 1, the BSR manages and distributes RP information between and among multiple RPs of a PIM-SM network. To that end, the BSR receives periodic updates from RP(s) associated with different multicast groups. In the preferred embodiment, these periodic updates are contained within C-RP advertisements from the DCRP. After sending the C-RP advertisement, the DCRP waits at step 604 a predetermined time interval (“C-RP Advertisement Interval”) before sending the next advertisement.

At step 606, the DCRP determines whether there is more than one candidate RP for its group range “X.” In response to a negative determination at step 606, the DCRP determines at step 608 that it is the active RP for group range X. Otherwise, if there is a positive determination at step 606, an RP election is performed at step 610 among the candidate RPs. Methods of performing RP election are known in the art and will not be described in detail herein. Note that the RP election differs from the DCRP/VCRP election described in relation to FIG. 5. If the DCRP is not elected as RP, it remains in the candidate RP state at step 614 and the process ends.

If the DCRP is elected as RP, the process proceeds to steps 616-622 to process packet(s) received by the DCRP (acting as RP). Whenever the DCRP receives a Join (or Prune) packet (step 616), the DCRP determines at step 618 whether the packet is received on an interface towards the VCRP. Thus, for example, with reference to FIG. 2, the Join message 202 will have been received by the DCRP (e.g., R1) on the interface towards the VCRP (e.g., R2). In such case, the DCRP knows that the VCRP has already received the packet and absorbed the associated state information. The DCRP then awaits further packets at step 616, 620 without sending state information to the VCRP. Conversely, if at step 618, the DCRP determines that a Join or Prune packet is not received on an interface towards the VCRP, it sends state information to the VCRP at 622 to facilitate the VCRP performing a rapid takeover of DCRP functionality, if necessary. In one embodiment, whenever the DCRP receives a data packet (step 620), it sends state information to the VCRP before returning to steps 616, 620 to await further packet(s).

FIG. 7 is a flowchart showing VCRP behavior according to one embodiment of the present invention. The steps of FIG. 7 are implemented, where applicable, using stored software routines within the VCRP (e.g., R2) elected (or non-elected as DCRP) among a plurality of candidate RP(s) for a particular group range.

At step 702, the VCRP receives a Join (or Prune) packet. Upon receiving the Join or Prune packet, the VCRP determines at step 704 whether the packet is received on an interface towards the DCRP. If so, the VCRP knows that the DCRP has already received the packet and absorbed the associated state information. The VCRP then creates/maintains state information for the group(s) in the packet at step 708 and awaits further packets at step 702, 710 without forwarding the Join or Prune packet to the DCRP. Conversely, if at step 704, the VCRP determines that a Join or Prune packet is not received on an interface towards the DCRP, it forwards the packet to the DCRP at step 706 before creating/maintaining state information at step 708.

In one embodiment, at step 710, the VCRP receives periodic Hello messages with state information (e.g., PIM Hello with ‘Group Information Option’). Whenever the VCRP receives a Hello packet with state information, it creates/maintains state information at step 712 and returns to step 710 to await further Hello packet(s).

FIG. 8 is a flowchart showing VCRP behavior upon failure of a DCRP according to one embodiment of the present invention. The steps of FIG. 8 are implemented, where applicable, using stored software routines within the VCRP (e.g., R2) elected (or non-elected as DCRP) among a plurality of candidate RP(s) for a particular group range.

At step 802, the VCRP detects failure of the DCRP. In one embodiment, the VCRP receives periodic hello messages from the DCRP and failure of the DCRP is detected upon the VCRP missing a designated number of hello messages (e.g., three) from the DCRP. As will be appreciated, failure of the DCRP might also be detected upon different numbers of missed messages, time thresholds, or generally any alternative manner known or devised in the future.

At step 804, after detecting failure of the DCRP, the VCRP determines whether there are any other VCRPs (i.e., other than itself) for its group range “X.” If there are no other VCRPs, the VCRP elects itself as DCRP for the group range “X” and the process ends. If there are multiple VCRPs for the same group range “X,” a DCRP election is held at step 808 to determine which of the VCRPs will serve as DCRP. One manner of DCRP election is described in relation to FIG. 5. In one embodiment, the elected DCRP (i.e., former VCRP) will serve as DCRP until such time as the former DCRP recovers, as will be described in relation to FIG. 9.

FIG. 9 is a flowchart showing behavior of an acting DCRP (formerly a VCRP) upon recovery of a former DCRP according to one embodiment of the present invention. The steps of FIG. 9 are implemented, where applicable, using stored software routines within the acting DCRP (e.g., R2, FIG. 3) for a particular group range.

At step 902, the acting DCRP determines that the former DCRP has recovered. For example, with reference to FIG. 3, the router R2 determines that router R1 has recovered. In one embodiment, recovery of the former DCRP is detected upon the acting DCRP receiving hello message(s) from the former DCRP. As will be appreciated, recovery of the former DCRP might also be detected upon receiving messages other than hello messages, or upon receiving messages from device(s) other than the recovered DCRP.

At step 904, a DCRP election is held among the acting DCRP and former DCRP. Optionally, the DCRP election may include one or more VCRPs. In one embodiment, the DCRP election is accomplished in substantially the same manner described in relation to FIG. 5. It is presumed that such election, having once elected the former DCRP (e.g., R1) over the acting DCRP (e.g., R2), will again result in election of the former DCRP. The former DCRP (e.g., R1, FIG. 4), now recovered, re-assumes the active DCRP state. At step 906, the acting DCRP (e.g., R2, FIG. 4), having lost the election to the former DCRP, re-assumes the VCRP state. Then, at step 908, the VCRP (e.g., R2) sends all state information that it acquired while acting as DCRP to the recovered, re-elected DCRP (e.g., R1) and the process ends.

Alternatively, the election at step 904 of a DCRP upon recovery of a former DCRP may be accomplished with different criteria than the original election, such that the former DCRP is not necessarily re-elected as active DCRP. For example, it is envisioned that the election at step 904 might give higher priority to the acting DCRP, so as to retain the acting DCRP in the active DCRP state and cause the former DCRP to assume a VCRP state. In such case, of course, there would be no need for the acting DCRP to “re-assume” an active DCRP state, nor would the acting DCRP send state information to itself. Note that in this case too, the acting DCRP will still send state information to the VCRP (former DCRP), in order to keep the state current in the latter, for immediate takeover if the acting DCRP failed.

Now turning to FIG. 10, there is shown a portion of a multicast network 1000 having geographically separate domains 1006, 1008. As shown, the domains 1006, 1008 are different internet domains associated with different internet service providers (e.g., ISP 1, 2). As will be appreciated, the separate domains may comprise virtually any combination and type(s) of multicast domains, including but not limited to internet domains and public or private multicast-based radio communication system domain(s). Generally, each of the domains 1006, 1008 comprises a plurality of router elements 1002 interconnected by links 1004. The router elements 1002 are functional elements that may be embodied in separate physical routers or combinations of routers. For convenience, the router elements will hereinafter be referred to as “routers.” The link 1004 between exit routers ER1, ER2 typically comprises a WAN link, such as Frame Relay, ATM or PPP, whereas within ISP 1, ISP2, the links 1004 typically comprise LAN links. Generally, the links 1004 may comprise generally any medium (for example, any commercial or proprietary LAN or WAN technology) operable to transport IP packets between and among the routers 1002 and any attached hosts.

According to one embodiment of the present invention, where a network includes multiple domains, a separate active RP is selected for each of the domains 1006 for a given multicast group range. As shown, router R1 is the active RP for domain 1006 and router R3 is the active RP for domain 1008. To facilitate rapid failover from the active RP to a backup RP in the event of failure of any of the active RP(s), DCRP(s) and VCRP(s) are elected on each subnet generally as described in relation to FIG. 1. As shown, R1 is DCRP (“DCRP1”) and R2 is VCRP for their shared subnet within domain 1006; and R3 is DCRP (“DCRP2”) and R4 is VCRP for their shared subnet within domain 1008. Routers “ER1” and “ER2” are exit routers interconnecting the respective domains 1006, 1008 by link 1004.

As shown, routers DCRP1 and DCRP2 are both elected as active RP within their shared subnets. Thus, the network 1000 includes multiple, simultaneously active RPs. In one embodiment, multiple, simultaneously active RPs (e.g., DCRP1, DCRP2) are implemented using Anycast IP with Multicast Source Discovery Protocol (MSDP) peering (illustrated by functional link 1010) between DCRPs. Generally, MSDP peering is used to establish a reliable message exchange protocol between active RPs and also exchange multicast source information. Significantly, according to the preferred embodiment of the present invention, MSDP peering is established only between the DCRPs of separate subnets. That is, there is no MSDP peering between VCRPs (at least until such time as VCRP(s) assume DCRP functionality). Thus, as has been described in relation to FIG. 1, the DCRP is effectively an active candidate RP and the VCRP is a passive candidate RP for a particular subnet. Remaining functions performed by the DCRP are substantially as described in relation to FIG. 6 and the functions performed by the VCRP are substantially as described in relation to FIG. 7. The behavior of a VCRP upon failure of a DCRP is shown in FIG. 8; and the behavior of the VCRP (having become an active DCRP after having taken over the DCRP function) upon recovery of the former DCRP is shown in FIG. 9.

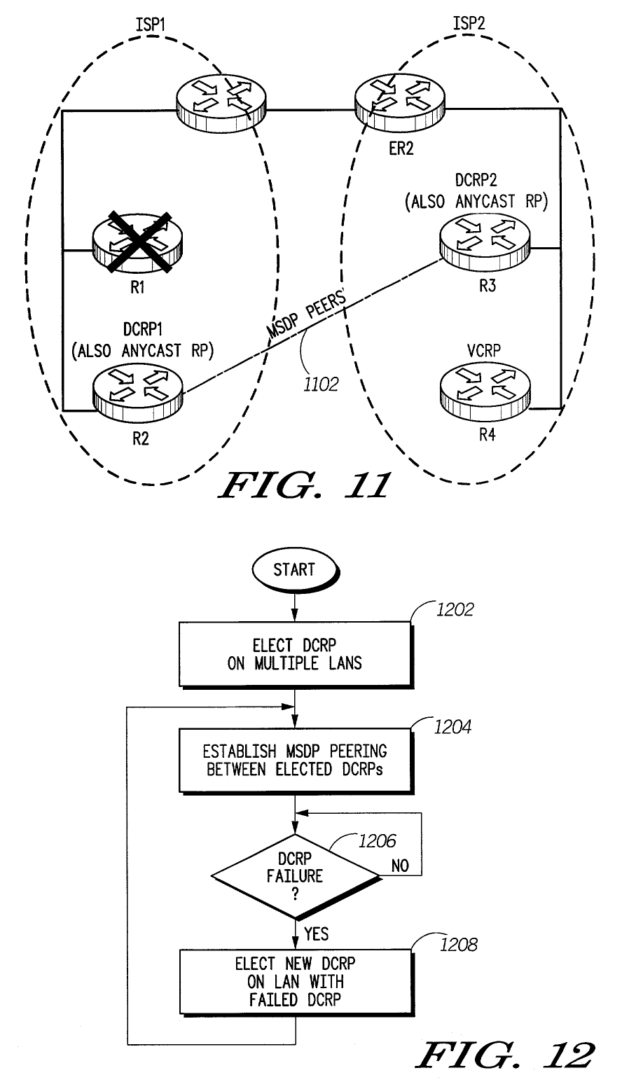

FIG. 11 shows the multicast network of FIG. 10 after the initial DCRP 1 (e.g., R1) becomes failed on the shared subnet of ISP 1, causing DCRP functionality to transition to the former VCRP (now DCRP) R2. Thus, R1 becomes a former DCRP and R2 becomes an acting DCRP in ISP1. This results in ISP1 having, at least temporarily, a single DCRP and zero VCRPs. FIG. 11 presumes that R2, upon assuming acting DCRP1 functionality, is also elected anycast RP. The acting DCRP1 (e.g., R2) establishes an MSDP peering 1102 with DCRP2.

FIG. 12 is a flowchart showing steps performed to establish DCRPs in geographically separate domains and, upon DCRP failure, to elect new DCRP(s) according to one embodiment of the present invention. The steps of FIG. 12 are implemented, where applicable, using stored software routines within the DCRPs and VCRPs of geographically separate domains.

At step 1202, DCRPs are elected from candidate RPs on multiple LANs (i.e., on multiple shared subnets). Then, at step 1204, MSDP peering is established between the elected DCRPs. Thus, for example, with reference to FIG. 10, R1 is elected DCRP1 in the shared subnet of domain 1006 and R3 is elected DCRP2 in the shared subnet of domain 1008; and MSDP peering is established between DCRP1 and DCRP2.

At step 1206, it is determined whether there is a DCRP failure. DCRP failure may be detected by a peer DCRP or VCRP missing a designated number of hello messages (e.g., three) from the failed DCRP. As will be appreciated, failure of the DCRP might also be detected upon different numbers of missed messages, time thresholds, or generally any alternative manner known or devised in the future. Upon detecting a DCRP failure, a new DCRP is elected at step 1208 on the LAN (or shared subnet) with the failed DCRP. Thus, for example, with reference to FIG. 11, upon detecting failure of R1, R2 is elected as the new, acting DCRP on the shared LAN of R1, R2.

The present disclosure has identified methods for providing RP redundancy in a sparse mode multicast network in a manner that facilitates a more seamless, rapid failover from designated RP(s) to a backup RP(s). Failover can be reduced to a few seconds without significant adverse effects on bandwidth or performance of the routers. The methods allow for multiple, geographically separate RPs to be simultaneous active when needed, while providing redundancy with VCRPs and while providing MSDP peering only between active DCRPs of different domains.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a packet network including a plurality of operably connected router elements, whereby in a sparse mode multicast protocol, one or more of the router elements are configured as candidate rendezvous points, and whereby two or more of the candidate rendezvous points share a common link, defining a shared subnet, a method comprising:
selecting, from among the candidate rendezvous points of the shared subnet, a single designated candidate rendezvous point (DCRP) and zero or more virtual candidate rendezvous points (VCRPs).

2. The method of claim 1, wherein the DCRP is eligible to serve as an active rendezvous point (RP) and the VCRPs serving as backup to the DCRP.

3. The method of claim 1, wherein the candidate rendezvous points of the shared subnet share a common IP address.

4. The method of claim 1, accomplished in PIM-SM protocol.

5. The method of claim 1, wherein the step of selecting a single DCRP and zero or more VCRPs comprises:
exchanging indicia of priority between the candidate rendezvous points of the shared subnet;
selecting a DCRP from among one or more candidate rendezvous points having a highest priority; and
designating as VCRPs, zero or more candidate rendezvous points not selected as DCRP.

6. The method of claim 5, further comprising exchanging IP addresses between the candidate rendezvous points of the shared subnet.

7. The method of claim 6, wherein upon any of the candidate rendezvous points having a null priority, the step of selecting a DCRP comprises:
determining the DCRP based on IP addresses of the candidate rendezvous points.

8. The method of claim 6, wherein upon two or more candidate rendezvous points sharing highest priority, the step of selecting a DCRP comprises:
determining the DCRP based on IP addresses of the two or more candidate rendezvous points.

9. The method of claim 6, wherein the steps of exchanging indicia of priority and exchanging IP addresses is accomplished by exchanging hello messages with RP option.

10. The method of claim 1, wherein the step of selecting yields a DCRP and one or more VCRPs, the method further comprising:
detecting failure of the DCRP, the failed DCRP thereby defining a former DCRP; and
selecting an acting DCRP from among the one or more VCRPs, yielding zero or more VCRPs.

11. The method of claim 10, further comprising:
detecting recovery of the former DCRP;
re-selecting the former DCRP as active DCRP;
re-assigning the acting DCRP as a VCRP; and
sending state information from the VCRP to the DCRP.

12. The method of claim 10, further comprising:
detecting recovery of the former DCRP;
assigning the former DCRP as a VCRP; and
sending state information from the DCRP to the VCRP.

13. In a packet network including a designated candidate rendezvous point (DCRP) and a virtual candidate rendezvous point (VCRP) on a shared subnet, the DCRP serving as an active rendezvous point (RP) for a multicast group according to a sparse mode multicast protocol, a method comprising:
receiving, by the DCRP, a control message comprising one of a Join message and Prune message associated with the multicast group;
determining, by the DCRP, whether the control message was received by the VCRP; and
if the control message was determined not to be received by the VCRP, sending the control message from the DCRP to the VCRP.

14. The method of claim 13 further comprising:
receiving, by the VCRP, a control message comprising one of a Join message and a Prune message associated with the multicast group;
determining, by the VCRP, whether the control message was received by the DCRP; and
if the control message was determined not to be received by the DCRP, sending the control message from the VCRP to the DCRP.

15. The method of claim 13 further comprising:
receiving, by the VCRP from the DCRP, a group information message associated with the multicast group;
extracting, by the VCRP, state information from the group information message.

16. The method of claim 15, wherein the group information message comprises:
a multicast IP address associated with the multicast group;
an IP address of at least one of a sending host and a receiving host of the multicast group; and
indicia of one of a Join message and Prune message.

17. In a packet network including a designated candidate rendezvous point (DCRP) and a virtual candidate rendezvous point (VCRP) on a shared subnet, the DCRP serving as an active rendezvous point (RP) for a multicast group according to a sparse mode multicast protocol, a method comprising:
receiving, by the DCRP, a data packet associated with the multicast group;
extracting, by the DCRP, state information from the data packet; and
sending the state information from the DCRP to the VCRP.

18. The method of claim 17 further comprising:
receiving, by the VCRP from the DCRP, a group information message associated with the multicast group;
extracting, by the VCRP, state information from the group information message.

19. The method of claim 18, wherein the group information message comprises:
a multicast IP address associated with the multicast group;
an IP address of at least one of a sending host and a receiving host of the multicast group; and
indicia of a data message.

20. In a packet network including a plurality of operably connected router elements, whereby in a sparse mode multicast protocol, one or more of the router elements are configured as candidate rendezvous points, and whereby a plurality of sets of candidate rendezvous points share respective common links, defining a plurality of shared subnets, a method comprising:
selecting, from among the candidate rendezvous points of each of the shared subnets, a single designated candidate rendezvous point (DCRP) and zero or more virtual candidate rendezvous points (VCRPs).

21. The method of claim 20, further comprising:
establishing a reliable message exchange protocol between the DCRP of each of the shared subnets.

22. The method of claim 21, wherein the step of establishing a reliable message exchange protocol comprises establishing an MSDP peering between the DCRP of each of the shared subnets.

23. The method of claim 20, further comprising:
detecting failure of a DCRP on at least one of the shared subnets, the failed DCRP thereby defining a former DCRP; and
selecting an acting DCRP from among the one or more VCRPs on the shared subnet of the former DCRP, yielding zero or more VCRPs on the shared subnet of the former DCRP.

24. The method of claim 23, further comprising:
establishing a reliable message exchange protocol between the acting DCRP and the DCRP of each of the other shared subnets.

25. The method of claim 24, wherein the step of establishing a reliable message exchange protocol comprises establishing an MSDP peering between the acting DCRP and the DCRP of each of the other shared subnets.

26. The method of claim 23, further comprising:
detecting recovery of the former DCRP;
re-selecting the former DCRP as active DCRP on the shared subnet of the former DCRP;
re-assigning the acting DCRP as a VCRP on the shared subnet; and
sending state information from the VCRP to the DCRP.

27. The method of claim 26, further comprising:
establishing a reliable message exchange protocol between the re-selected DCRP and the DCRP of each of the other shared subnets.

28. The method of claim 27, wherein the step of establishing a reliable message exchange protocol comprises establishing an MSDP peering between the re-selected DCRP and the DCRP of each of the other shared subnets.
